(19) United States
(12) Patent Application Publication
(10) Pub. No.: US 2019/0293823 A1
(43) Pub. Date: Sep. 26, 2019

(54) ACOUSTIC LOGGING DATA PROCESSING USING WAVEFORM AMPLITUDE AND PHASE

(71) Applicant: Halliburton Energy Services, Inc., Houston, TX (US)

(72) Inventors: BAICHUN SUN, Perth, Western Australia (AU); Ruijia Wang, Singapore (SG); Chung Chang, Houston, TX (US)

(21) Appl. No.: 16/342,648

(22) PCT Filed: Dec. 14, 2016
(86) PCT No.: PCT/US2016/066582

§ 371 Date: Apr. 17, 2019

(51) Int. Cl. G01V 1/50; G01V 1/30; G01V 1/28; E21B 49/00

(52) U.S. Cl. CPC G01V 1/50; G01V 1/303; G01V 1/284; E21B 47/0005; G01V 2210/41; G01V 2210/47; G01V 2210/6222; E21B 49/00

(57) ABSTRACT

An acoustic logging system determines slowness picks using acoustic waveform phase and amplitude data. An amplitude-based first-arrival-picking (“FAP”) technique is applied to acquired waveforms to derive a first set of slowness picks, and a waveform phase coherence technique is also applied to derive a second set of slowness picks. The first and second slowness pick sets are then compared in a variety of ways to determine a final set of slowness picks.

### FIELD OF THE DISCLOSURE

The present disclosure relates generally to downhole logging and, more specifically, to methods for determining acoustic slownesses jointly using waveform amplitude and phase information.

### BACKGROUND

The collection of information relating to downhole conditions, commonly referred to as “logging,” can be performed by several methods including “logging while drilling” (“LWD”) and wireline logging. Downhole acoustic logging tools are often utilized to acquire various characteristics of earth formations traversed by the borehole. In such systems, acoustic waveforms are generated using a transmitter, and the acoustic responses are received using one or more receiver arrays. The acquired data is then utilized to determine the slownesses (velocities) of the formation to obtain a maximum slowness and a minimum slowness; and processing the maximum slowness and the minimum slowness obtained to determine the horizontal transverse acoustic anisotropy and the angular direction of the formation's maximum and minimum slownesses. The amount of anisotropy and the direction may be of use in well planning and cement or formation evaluation; for example, to direct perforation guns or assess wellbore stability.

Borehole waves generated by an acoustic impulse source consist of multiple complicated guided waves travelling along the borehole surrounded by rock. To extract slowness measurements from those mixed wave motions, such as compressional slowness (“DTC”) and shear slowness (“DTS”), or shear slowness from low-frequency screw waves in LWD cases, a 2D coherence map is generally used for such purposes. However, the identification and correct picking of these target wave modes from the 2D map are challenging, as it is often necessary to deal with the complications including a low signal-to-noise ratio (“SNR”), interferences of other wave modes, such as leaky-P wave, tool waves, Stoneley waves, road noises due to the tool movements, or aliases of these modes within the 2D coherence map. All of these reasons can contribute to a complicated borehole wave field, thus reducing the ability to make correct, simple and real-time automatic slowness picks.

### BRIEF DESCRIPTION OF THE DRAWINGS

FIG. 1 illustrates a phase coherence map (bottom) derived from the waveforms (top) can include additional aliased energy or interference from other wave modes;

FIG. 2 illustrates a Variable Density Layer derived from a 2D coherence map of FIG. 1, according to certain illustrative embodiments of the present disclosure;

FIG. 3 illustrates how a compression wave is picked incorrectly when strong interference appears in the picking time window, shown as spikes;

FIG. 4 illustrates a time-slowness window, or time-slowness masking, on a 2D coherence map in order to constrain the picks from jumping to an undesired time-slowness range, according to certain illustrative embodiments of the present disclosure;

FIG. 5 illustrates a 2D coherence, where the P-wave appears trimmed by the time-slowness mask;

FIG. 6 shows examples of monopole (top) and dipole (bottom) waveforms acquired in a hard formation, according to certain illustrative methods of the present disclosure;

FIG. 7 is a flow chart of a method 700 for acoustic logging whereby acoustic wave slowness is determined based on joint coherence and travel time estimation, according to certain illustrative methods of the present disclosure;

FIG. 8 is a workflow of a first-arrival-picking refinement method 900 which can be performed at block 706, according to certain alternative methods of the present disclosure;

FIG. 9 shows a comparison of refined first-arrival-picking slowness and the original first-arrival-picking slowness;

FIG. 10 is a flow chart of an alternative acoustic logging method 1100 in which the travel time and coherence techniques are applied sequentially, according to certain illustrative methods of the present disclosure;

FIG. 11 shows a graph defining a slowness range providing constraint for coherence map computation, which helps avoids spikes of pickings for later arrivals;

FIG. 12 illustrates slowness picks that show how the use of first-arrival-picking constraints remove the need for time-slowness masks in searching for slowness picks;

FIG. 13A illustrates an sonic/acoustic logging tool utilized in an LWD application, that acquires acoustic waveforms and performs the slowness determinations using the illustrative methods described herein; and

FIG. 13B illustrates an alternative embodiment of the present disclosure whereby a wireline acoustic logging tool acquires and generates slowness signals.

### DESCRIPTION OF ILLUSTRATIVE EMBODIMENTS

Illustrative embodiments and related methods of the present disclosure are described below as they might be employed in methods and systems to perform acoustic logging using amplitude and phase data of acoustic waveforms. In the interest of clarity, not all features of an actual implementation or methodology are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methodologies of the disclosure will become apparent from consideration of the following description and drawings.

As described herein, illustrative systems and methods of the present disclosure are directed to accurately determine slowness picks using acoustic waveform phase and amplitude data. In a generalized method, acoustic waveforms of a borehole are acquired. An amplitude-based first-arrival-picking (“FAP”) technique is applied to the waveforms to derive a first set of slowness picks. A waveform phase coherence technique is also applied to derive a second set of slowness picks. The first and second slowness pick sets are then compared to determine a final set of slowness picks, which form the log. Thereafter, a variety of borehole operations may be performed using the final slowness picks including, for example, formation or cement evaluation. Accordingly, through use of phase and amplitude information to constrain the picks, more accurate and reliable logs are provided.

As previously mentioned, borehole acoustic waveforms consist of multiple complicated guided waves. To extract slowness picks from those mixed wave motions, a 2D coherence map is generally used for such purposes. However, accurately selecting those target wave modes can be a challenge in light a various phenomenon, including low SNR and interference from other wave modes. As a result, methods that only apply a 2D coherence map reduce the ability to make accurate slowness picks.

To eliminate the interference of unwanted wave mode/noise or their aliasing, a time-slowness masking technique may be applied to the 2D coherence map to isolate those unwanted modes or noises. In general, this method works well in homogeneous or weak heterogeneous formations; however, in the case of complicated borehole conditions, for example, when the formation is strongly heterogeneous, the time masking technique fails because it is designed to minimize interferences based on the assumption the formation from source to the last receiver is homogeneous. As a result, the imposed time mask could potentially exclude the desired wave modes partially or fully and result in an inaccurate pick of slowness measurements. Since complicated waveforms are regularly encountered downhole, the selection (or “picking”) of targeted wave mode slowness using either of these methods in isolation has many disadvantages, such as jumping to alias or jitter of the logs.

Accordingly, in the illustrative methods described herein, a robust approach is provided to enhance the accuracy of real-time slowness trackings of P- or S-waves or other waves in acoustic logging. Unlike only the coherence measurement techniques, where only the phase component of the array waveforms is utilized for slowness tracking, the present disclosure also utilizes waveform amplitude information to better constraint the slowness picks. As a result, the complications of conventional approaches are done away with, thereby resulting in more accurate and reliable selection of the target slowness.

With an acoustic logging tool, waves excited by a monopole (Omni-directional) source travel along the borehole fluid and formation interface (i.e., borehole wall) and are recorded by an offset receiver array. As will be described herein, in order to obtain compressional slowness (the same method can also apply to extraction of Stoneley slowness, low-frequency flexural slowness, low-frequency screw slowness), processing of the recorded waveforms is based in-part on amplitude tracking of the first wave arrivals using the receivers positioned along the borehole axis. In addition, a time-slowness 2D coherence map is produced from time-domain processing, which exploits the phase coherent component without the consideration of the waveform amplitudes component for processing the non-dispersive waves.

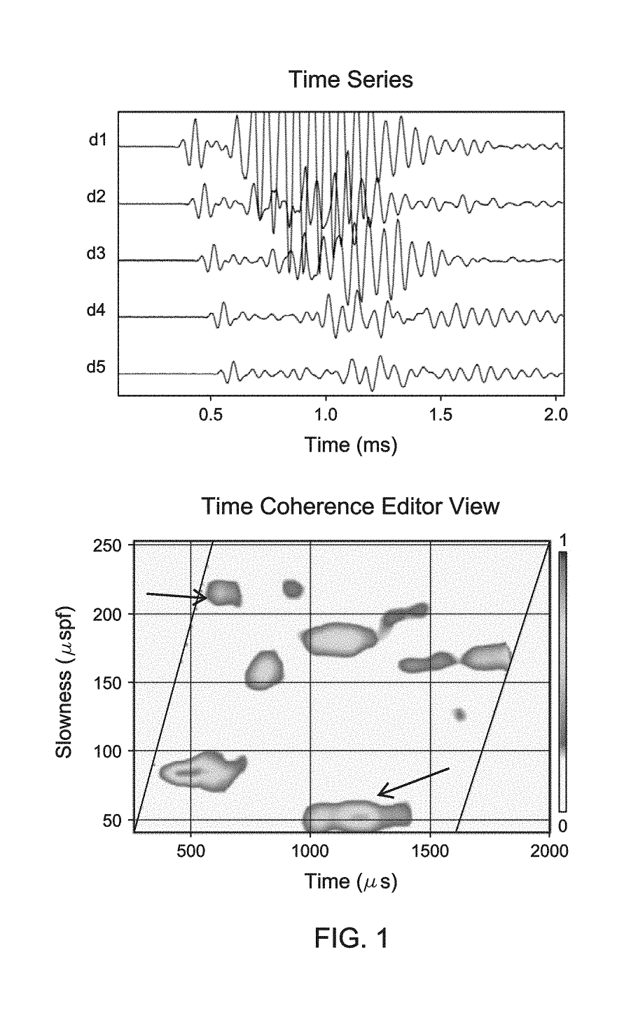

To understand the formation lithologies, porosity or fluid saturation, correctly extraction of the acoustic wave slowness has been an important topic in hydrocarbon exploration, as the array of waveforms can be complicated in difficult zones. FIG. 1 illustrates how a phase coherence map on the bottom (derived from the waveforms on the top) can include additional aliased energy or interference from other wave modes as indicated by arrows. As can be seen, the coherence map contain multiple coherent peaks. These coherent peaks include aliasing and waveform interference. It is also generally common to see multiple peaks due to leaky-P, reflections, road noises, etc. In real-time logging using this data alone, the lack of human intervention makes correct and consistent picking at consecutive depths of logging very challenging.

Therefore, to perform successful, automatic and intelligent processing, rejecting peaks from interfering noises is required. One method to assist in slowness picking is based on a 2D-map derived using a Variable Density Layer (“VDL”) technique. A VDL can be produced from various methods such as, for example, determining maximum coherence values of the 2D map along the time axis for a specific time range. Here, slowness picking may be made based on certain coherence threshold in certain embodiments.

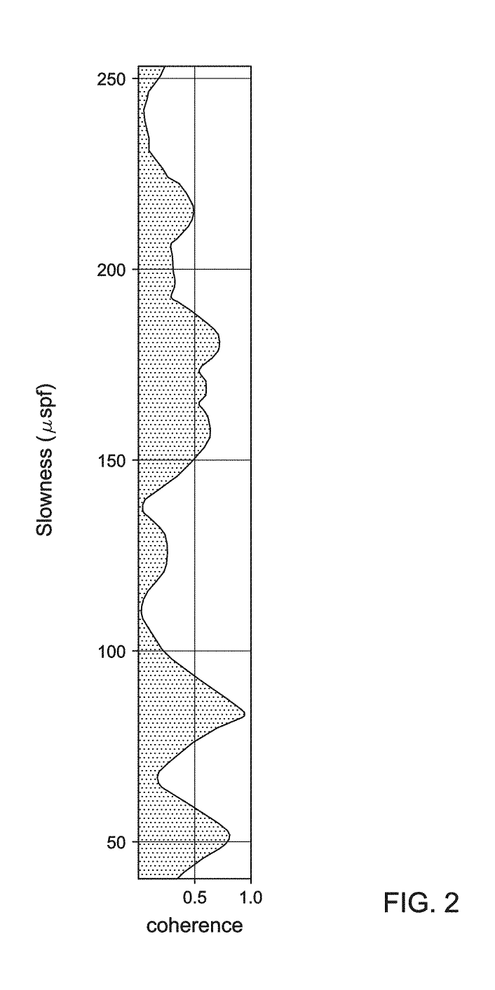

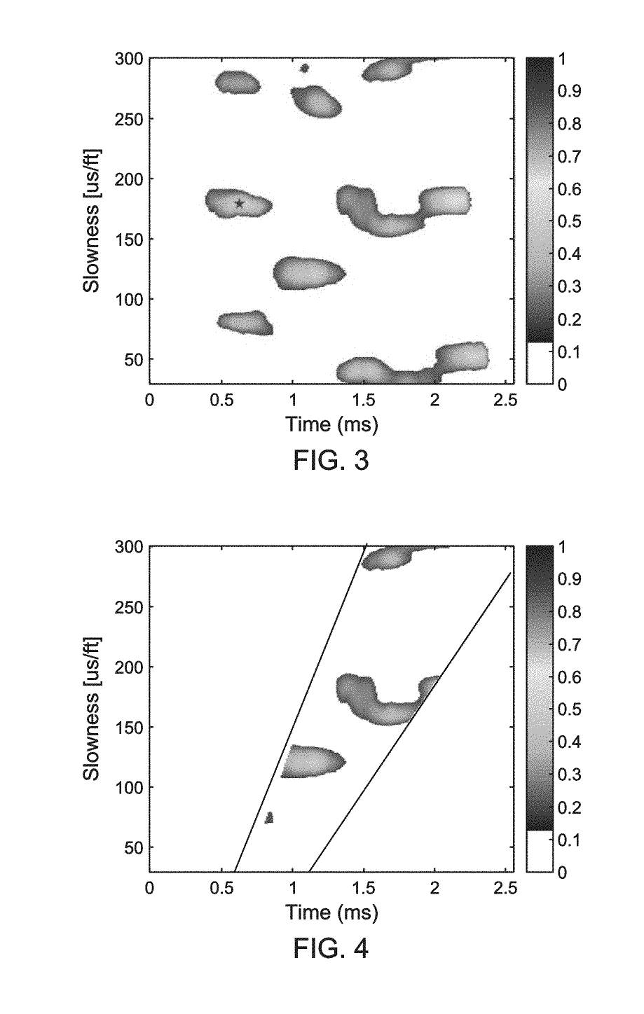

Due to the complications of the different wave modes, it is common the resulting VDL contains multiple peaks, for example shown in FIG. 2, which illustrates a VDL derived from the 2D coherence map of FIG. 1. A certain criteria or threshold may employed consistently throughout the logging processing to determine the slowness from the VDL, such as maximum amplitude of the VDL. In some difficult situations, however, the alias of the monopole waves may present the highest amplitude, but at a slower time, as that an incorrect slowness based on a certain amplitude threshold may be picked. For example, FIG. 3 illustrates how a compression wave is picked incorrectly when a strong interference/alias appears in the picking time window. The coherence map shows there are more than one peak at about the P-wave arrival time (˜0.7 ms), and the amplitude from the one at the higher slowness is higher, and then a pick is made to it (as indicated by the star). However, to one ordinarily skilled in the art, it is clear the early arrival is the correct answer.

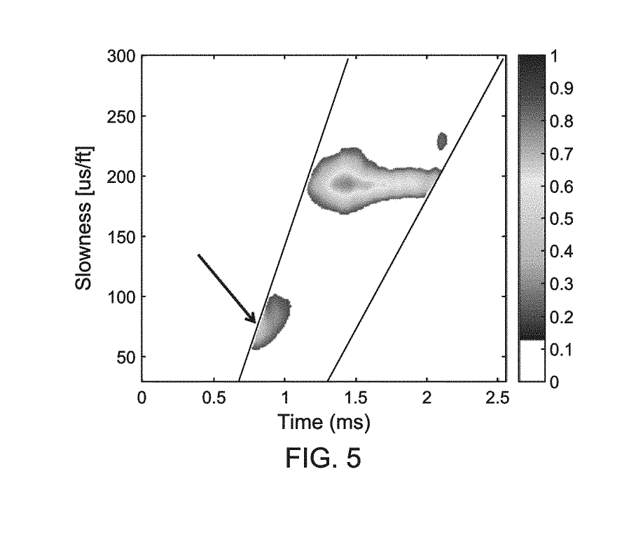

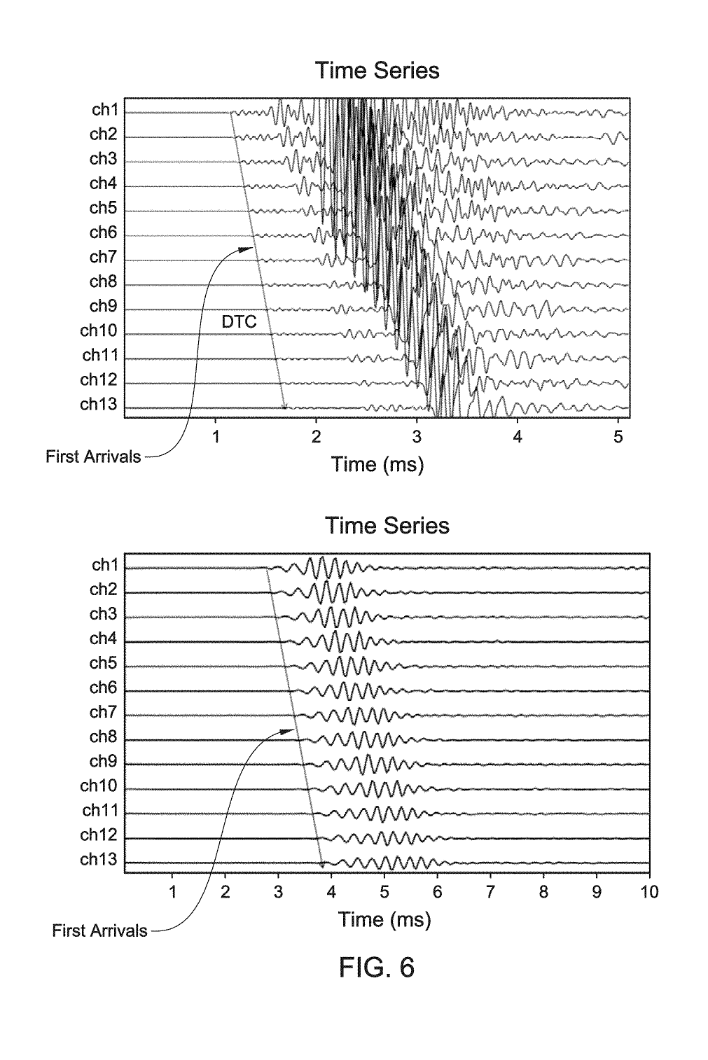

One illustrative method to control the spikes in slowness picking is to place a time-slowness window, or time-slowness masking, on the time-slowness 2D coherence map in order to constrain the picks from jumping to an undesired time-slowness range. FIG. 4 illustrates this phenomena based on the example of FIG. 3, and shows the desired time-slowness range identified between the two lines. In certain examples, in particular for real-time processing, the selection of a time-slowness window is based on the estimation of slowness and travel time according to the transmitter and receiver positions, as well as the borehole and the tool relative positions. The time-slowness window can be very effective in defining the correct time-slowness picking range. However, the design of time-slowness window needs to be careful in order to avoid trimming of necessary coherent information. Comparing FIG. 3 and FIG. 4, the true P-wave slowness at about 75 us/ft is trimmed off by the time-slowness window. Another example of bad time-slowness window definition is shown in FIG. 5.

In addition to the time-slowness masking method, another solution includes the use of P- and S-wave slowness ratio to control slowness picking. However, this solution is only applicable to hard formation wells.

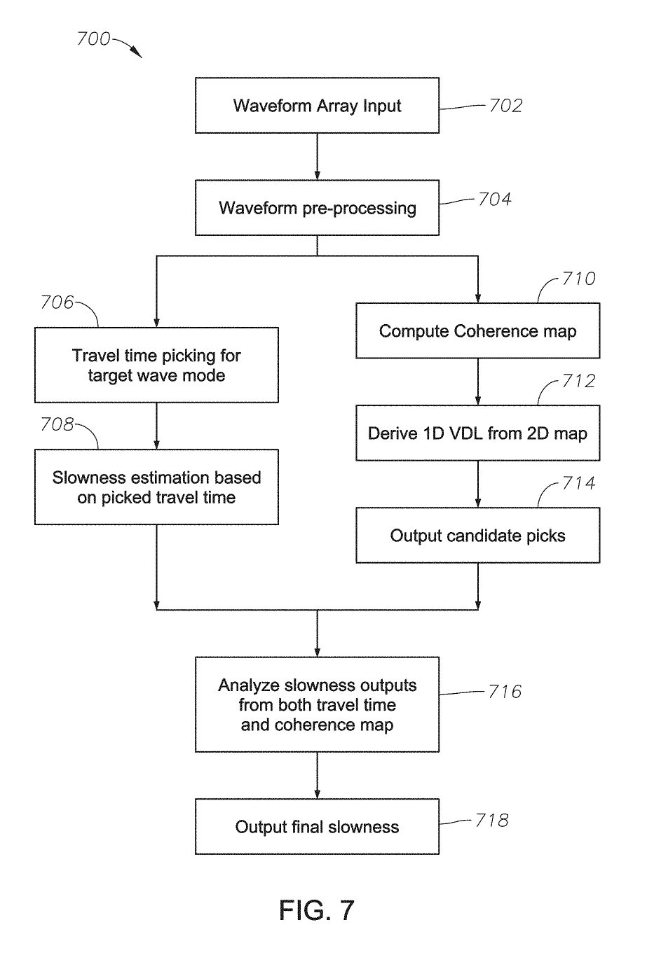

Accordingly, in view of the foregoing, illustrative methods and embodiments of the present disclosure present a joint method using both a 2D phase coherence map and the amplitude derived FAP time and slowness. Thus, the methods are based on tracking of large amplitude changes for each recorded signal, while also maintaining the 2D coherence map and VDL from the receiver array. FIG. 6 shows examples of monopole (top) and dipole (bottom) waveforms acquired in a hard formation. The first P-wave arrivals on the left or flexural waves on the right are identified as lines across the array. The first arrival normally has good SNR and can be tracked for slowness determination. The move out of FAP can be tracked throughout the depths of acquisition during acoustic logging, and determination of the move out slowness of corresponding wave modes. In contrast, the coherence technique utilizes the coherence along the first arrival waveforms for slowness picking, but it uses the coherent phase information, such as the differential phase method. Thus, the amplitude information is missing, so although aliases commonly exist in the 2D map, slowness from FAP contains no aliased possibility. Therefore, the combination of these two methods in the present disclosure are closely related and, therefore, can be implemented simultaneously or sequentially to constrain the picking of target wave modes.

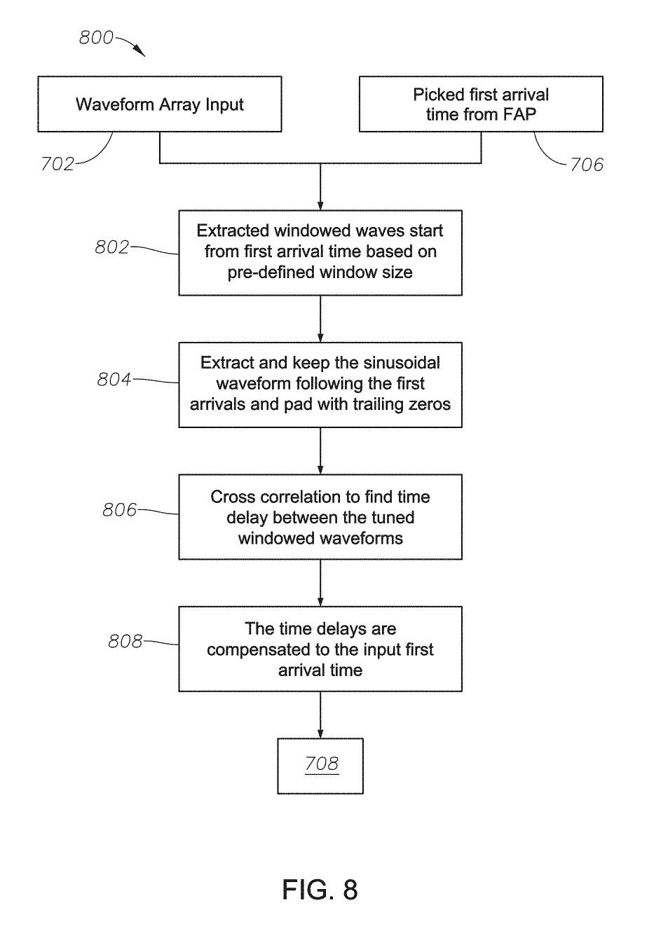

FIG. 7 is a flow chart of a method 700 for acoustic logging whereby acoustic wave slowness is determined based on joint phase coherence and amplitude defined travel time estimation, according to certain illustrative methods of the present disclosure. In FIG. 7, the workflow of this illustrative joint picking method is presented. At block 702, an array of waveforms from monopole or dipole firings are acquired and provided to the acoustic logging system as input. At block 704, preprocessing of the waveforms is performed to better condition the data, such as, for example, DC removal, filtering the waves to suppress noises and conserve the frequency band of monopole firing, and waveform interpolation—all of which may be applied when improved accuracy and coherence of the first arrival is important. In this illustrative method, an effective filter can suppress the very low frequency band energy in order to improve the accuracy of the FAP to be used in the later blocks. After the signals are prepared at block 704, they are transmitted into two parallel/simultaneous joint picking processes beginning at blocks 706 and 710, including the picking of those first arrival waveforms using the amplitude break, and computation of a 2D coherence map for VDL computation, as will be discussed in detail below.

At block 706, the onsets of first-break travel times are picked for the target wave mode. For modern acoustic logging tools, the selection of target wave modes based on amplitude breaks can be implemented with various methods. For example, in certain illustrative methods the wave arrival time is determined using two consecutive sliding windows, and the ratio of energy, entropy, etc. may be calculated for each window to indicate the abrupt change in the time axis. Alternatively, correlation of the windowed waveform method can be used for the same purpose. In block 706, the FAP from receiver to receiver is tracked to ensure the process does not introduce significant bias.

After the FAP of all waveforms in the receiver array are determined at block 706, the slowness of the target wave is derived for the specific wave mode at block 708. In certain methods, the determination of slowness at block 708 is achieved using a linear data fitting method corresponding to the arrival times. Equation (1) below, namely:

t=t₀+s×Δx Eq. (1),

demonstrates the relationship between travel time t, initial arrival time t₀ and receiver offset Δx, and how the slowness s may be determined using this linear fitting method. In certain examples, multiple passes of linear fitting are needed to reject any outliers if necessary. Thereafter, the slope of the linear regression is the output slowness of block 708.

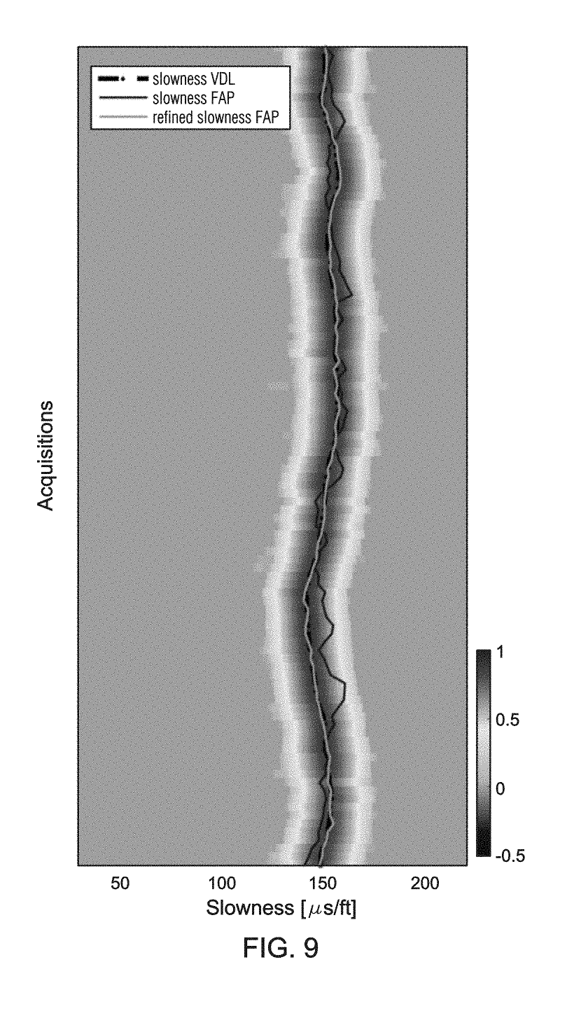

In certain illustrative methods, the accuracy of time delay between receivers can be further improved based on the initial picking of the FAP. In one example, the improvements are achieved through the correlation of the sinusoidal waveforms following the initial FAP at block 706. FIG. 8 is a workflow of an FAP refinement method 800 which can be performed at block 706, according to certain alternative methods of the present disclosure. From the picked first arrival time at block 706 and the array input of block 702, pre-defined windowed waveforms are extracted starting from the FAP at block 802, which include the waveforms of the first arrival wave mode. Then at block 804, the half or full period of the first signal is extracted using a zero-crossing method, and the values of the windowed waveforms are replaced with trailing zeros.

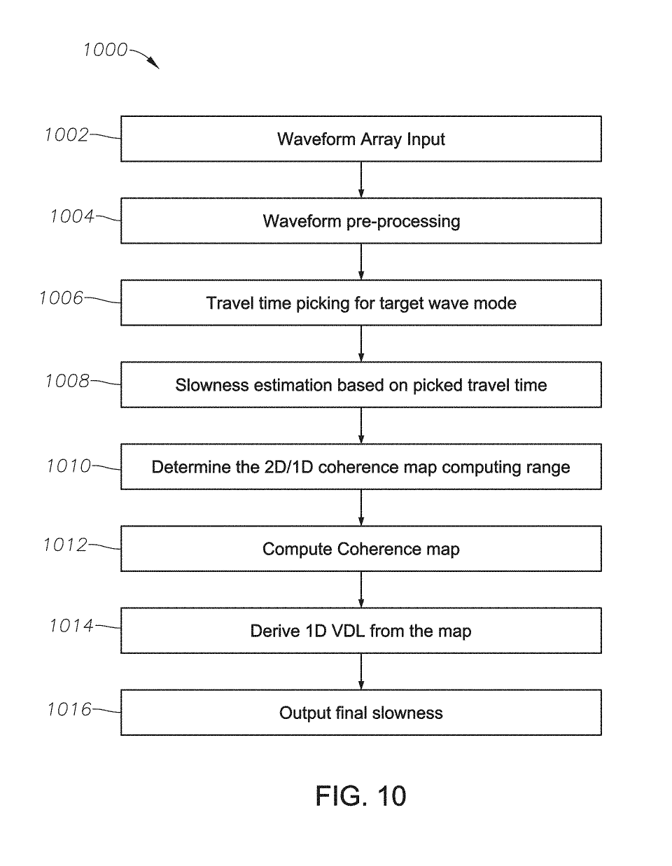

Next, at block 806, to find the time delay between the tuned windowed waveforms at the receivers, cross-correlation is performed with either the extracted wavelet or one of the windowed waveforms. In block 806, the extraction of wavelets can be obtained by shifting and aligning those windowed waveforms, and deriving the average or median waveform. Finally, at block 808, these time delays against the reference waveform are used to update the initial first arrival time estimation. In certain methods, the refined arrival time can be used to perform the same linear regression process to derive slowness at block 708, or the slowness can be estimated based on the
distance between source and receiver and the travel time at block 708. Also, at block 708, the time delay may be checked to remove outliers in certain illustrative methods. The refined processing generally will lead to more accurate estimation of slowness at block 708. For example, FIG. 9 shows a comparison of refined FAP slowness and the original FAP slowness. As can be seen, the slowness derived from the original FAP is inferior to the refined FAP, as the refined FAP has a very close match to the semblance peak (VDL).

With reference back to FIG. 7, simultaneously while the FAP technique is being applied, at block 710, a coherence technique is being used for the slowness pickings at block 710. In this example, a time domain coherent 2D map is useful due to arrival time separations of different modes. Various methods can be used to compute the coherence map, such as, for example, the time-domain differential phase method.

At block 712, a 1D VDL (e.g., FIG. 2) is derived from the coherence map and used to perform picking. As previously mentioned, it is common to see multiple peaks in the VDL, including aliases. Without any other constraints, conventionally, the slowness corresponding to the maximum coherence is picked. However, in the illustrative methods described herein, all candidate picks are output at block 714 based on a pre-defined coherence threshold such as, for example, 0.2. The attributes of all outputs include their coherence, travel time and slowness values information.

At block 716, the slowness picks of the linear regression derived slowness of the FAP (block 708) and candidate slowness picks from 2D coherence map (block 714) are jointed (e.g., compared) to determine the final output slowness picks. The joint determination may be conducted in a variety of ways. In certain illustrative methods, a taper function is applied based upon the slowness picks of the linear regression of block 708. The taper function is applied to the candidate picks' VDL (block 714) to suppress the coherent peaks according to its distance from the linear regression derived slowness (block 708). After the taper function has been applied, the remaining coherence peak(s) (X) are compared to slowness pick from FAP S_{FAp} to define the final slowness output in Equation 2 at block 718.

s=Min{|x−S_{FAP}|}, x∈X, Eq. (2),

In an alternative method, the slowness picks from the linear regression (block 708) is sequentially compared to (or used to constrain) all VDL candidate slowness picks (block 714) to thereby locate the slowness with the minimum distance from the linear regression slowness. If there are multiple remaining candidates, the coherence value is normally used as a critical criteria to determine the final slowness picks. In some unusual situations, if there are still comparable coherence peaks on the 2D coherence map, the candidate picks will be further compared based on their travel time and slowness. If there are reference values, such as previous acquisition output, or known slowness or travel time of other corresponding wave modes, these information can be utilized to help to derive the final output. When one branch output is invalid, such as an unrealistically slow or fast, the output can be evaluated based on the consistency of cached slowness value from previous acquisitions. Nevertheless, after the final slowness picks are output at block 718, they may be applied to perform a variety of downhole operations including, for example, formation or cement evaluation.

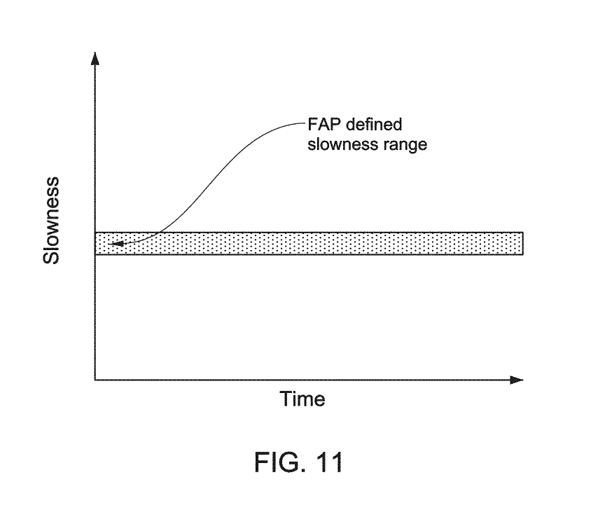

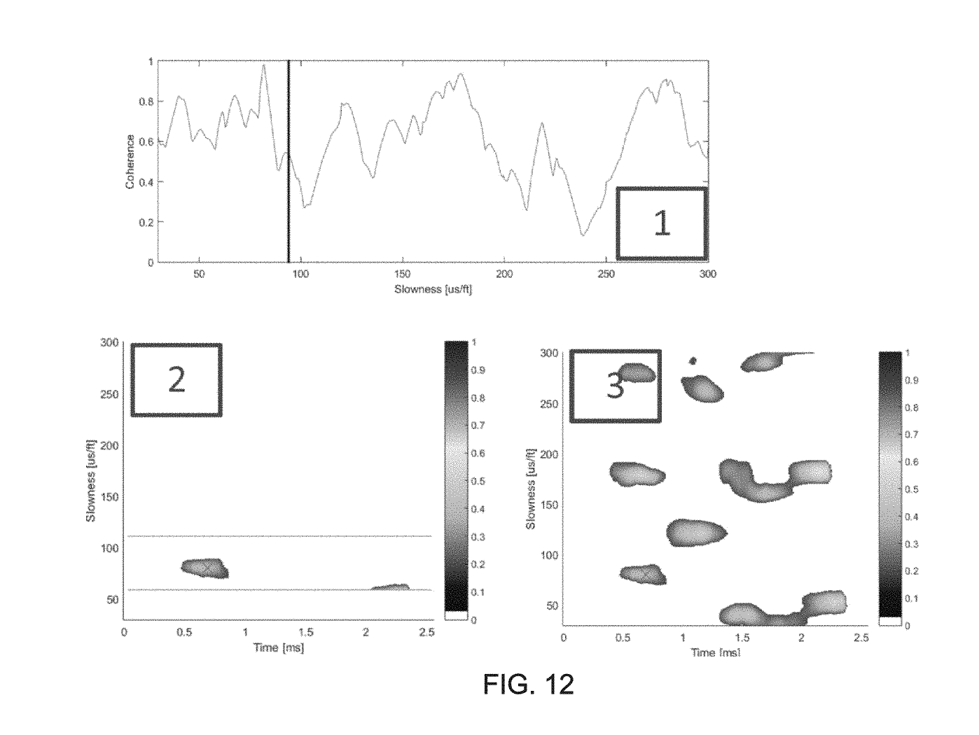

FIG. 10 is a flow chart of an alternative acoustic logging method 1000 in which the travel time and coherence techniques are applied sequentially, according to certain illustrative methods of the present disclosure. The difference as compared it to the workflow in FIG. 7 is that the output of slowness picks from the FAP technique is directly used to define a narrow coherence computation range. At block 1002, the waveform array is input and preprocess at block 1004 as previously described. At blocks 1006 and 1008, the travel time picking and slowness estimation is performed. At block 1010, based on the determined slowness and travel time outputs from waveform amplitude processing, on the time-slowness coherence map, both time and slowness can be narrowed to constrain the picking and computation range, and a limited slowness search range is determined for the coherence computation using a slowness and time range threshold. For example, FIG. 11 shows a graph which illustrates a defined slowness range providing constraint for coherence map computation, which helps avoids spikes of pickings for slower noises or aliases. Only the FAP slowness range of the 2D map is needed for calculation, and the pickings will be made in that range. Thereafter, the coherence map is computed at block 1012, the VDL is derived at block 1014, and the final slowness picks are output at block 1016, as previously described herein. The merit of this work flow is that it reduces the computing range and time, as compared to it the workflow in FIG. 7.

It is notable that the slowness picks from the FAP based on amplitude processing is the group slowness. Also, for the non-dispersive or weak-dispersive waves, the group slowness is the same or close to its phase slowness. Therefore, in certain illustrative methods, one slowness answer may be used to validate or constrain the other answer, in order to provide a converged result.

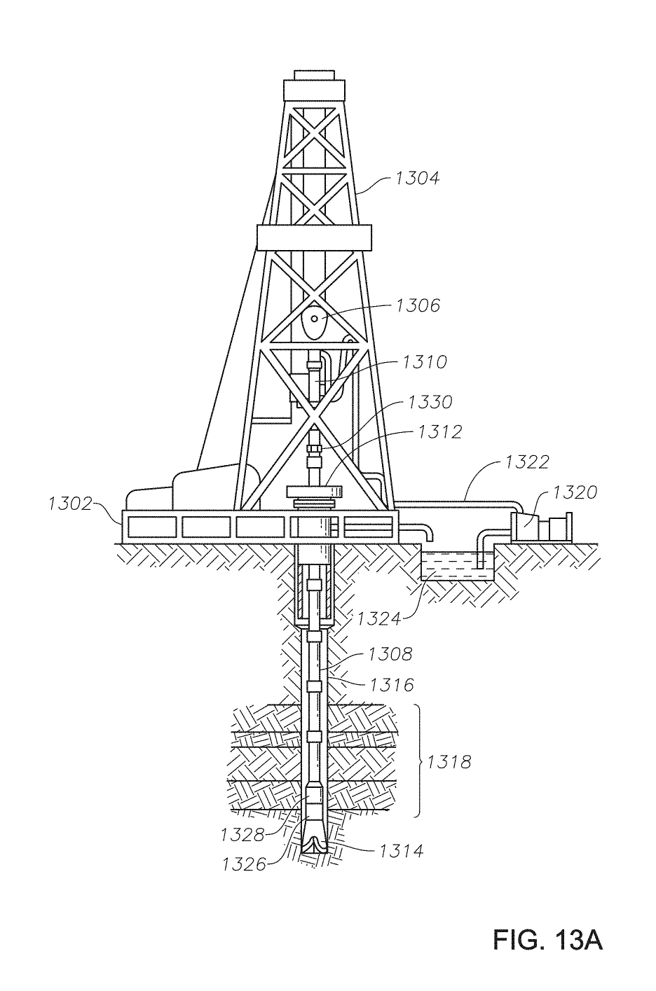

FIG. 12 illustrates a comparison of slowness processing between FIG. 3 and the illustrative methods described herein. In FIG. 12(1), the raw data VDL of time-slowness map is shown, and it is superpositioned by FAP derived slowness shown as the vertical line. The final pick is derived by comparing peaks of the VDL to the vertical line. In FIG. 12(2), here it illustrates an alternative method where the FAP derived slowness is used to define a picking slowness range, indicated by the horizontal lines, and then the coherence map is computed and final picking is implemented within it. In FIG. 12(3), it shows the final pick (denoted by the “x”) on the final time-slowness map. The correct pick is made due to the constraint from FAP slowness. At the same time, the trimming of the VDL is eliminated by discarding the time-slowness mask using this method. Clearly the FAP slowness is closely correlated to the final pick, and compared to the conventional semblance-only method, the spikes/jumps will be reduced significantly.

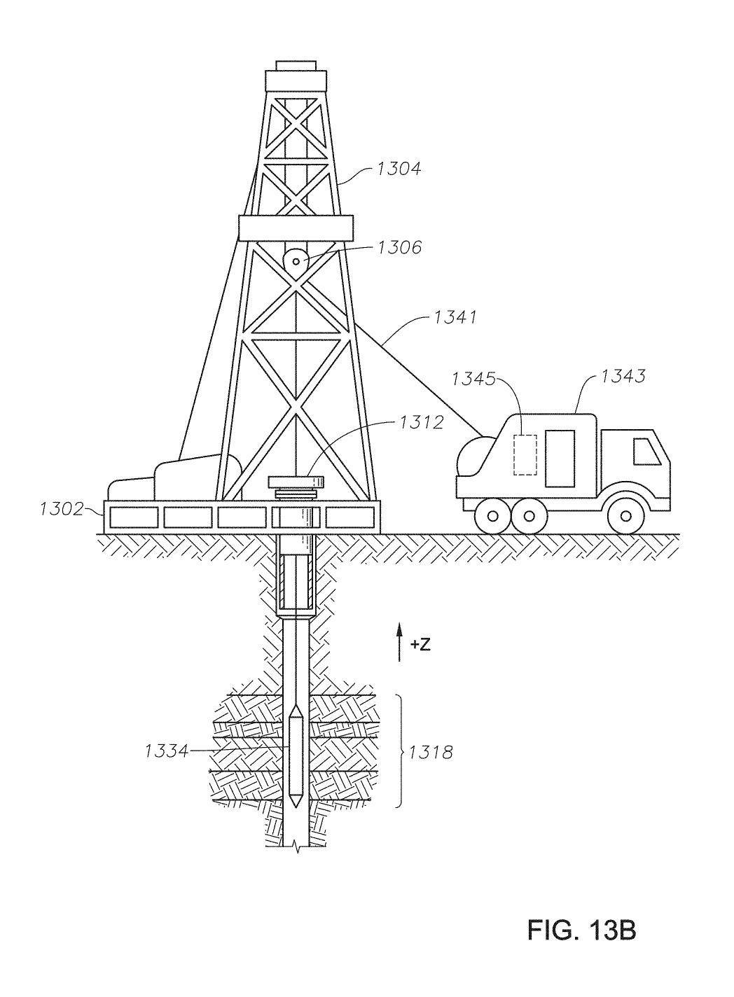

Illustrative methods of the present disclosure may be utilized in a variety of logging applications including, for example, LWD or MWD applications. FIG. 13A illustrates an sonic/acoustic logging tool utilized in an LWD application, that acquires acoustic waveforms and performs the slowness determinations using the illustrative methods described herein. The methods described herein may be performed by a system control center located on the logging tool or may be conducted by a processing unit at a remote location, such as, for example, the surface.

FIG. 13A illustrates a drilling platform 1302 equipped with a derrick 1304 that supports a hoist 1306 for raising and lowering a drill string 1308. Hoist 1306 suspends a top drive 1310 suitable for rotating drill string 1308 and lowering it through well head 1312. Connected to the lower end of drill string 1308 is a drill bit 1314. As drill bit 1314 rotates, it creates a wellbore 1316 that passes through various layers of a formation 1318. A pump 1320 circulates drilling fluid through a supply pipe 1322 to top drive 1310, down through the interior of drill string 1308, through orifices in drill bit 1314, back to the surface via the annulus around drill string 1308, and into a retention pit 1324. The drilling fluid transports cuttings from the borehole into pit 1324 and aids in maintaining the integrity of wellbore 1316. Various materials can be used for drilling fluid, including, but not limited to, a salt-water based conductive mud.

An acoustic logging tool 1326 is integrated into the bottom-hole assembly near bit 1314. In this illustrative embodiment, logging tool 1326 is an LWD sonic tool; however, in other illustrative embodiments, logging tool 1326 may be utilized in a wireline or tubing-conveyed logging application. If the logging tool is utilized in an application which did not rotate the downhole assembly, the logging tool may be equipped with azimuthally-positioned sensors which acquire the slowness measurement around the borehole. In certain other illustrative embodiments, acoustic logging tool 1326 may be adapted to perform logging operations in both open and cased hole environments.

In this example, acoustic logging tool 1326 will include multipole-capable transmitters and receiver arrays (not shown) which generate acoustic waves in geological formations and record their transmission. In certain embodiments, the transmitters may direct their energies in substantially opposite directions, while in others a single transmitter may be utilized and rotated accordingly. The frequency, magnitude, angle and time of fire of the transmitter energy may also be controlled, as desired. In other embodiments, the collected slowness measurements may be stored and processed by the tool itself, while in other embodiments the measurements may be communicated to remote processing circuitry in order to conduct the slowness processing.

Acoustic logging tool 1326 is utilized to acquire slowness measurement data at many azimuths. As such, certain embodiments may also include a directional sensor to determine the orientation of the tool. The illustrative methods described herein may be utilized in a variety of propagation modes, including, for example, borehole refracted compressional, shear, low frequency flexural, low frequency screw, quadropole or Stoneley modes.

Still referring to FIG. 13A, as drill bit 1314 extends wellbore 1316 through formations 1318, logging tool 1326 collects slowness measurement signals relating to various formation properties, as well as the tool orientation and various other drilling conditions. In certain embodiments, logging tool 1326 may take the form of a drill collar, i.e., a thick-walled tubular that provides weight and rigidity to aid the drilling process. A telemetry sub 1328 may be included to transfer slowness images and measurement data/signals to a surface receiver 1330 and to receive commands from the surface. In some embodiments, telemetry sub 1328 does not communicate with the surface, but rather stores slowness measurement data for later retrieval at the surface when the logging assembly is recovered.

In certain embodiments, acoustic logging tool 1326 includes a system control center (“SCC”), along with necessary processing/storage/communication circuitry, that is communicably coupled to one or more transmitters/receivers (not shown) utilized to acquire slowness measurement signals. In certain embodiments, once the acoustic waveforms are acquired, the system control center calibrates the signals, performs the slowness calculation methods described herein, and then communicates the data back uphole and/or to other assembly components via telemetry sub 1328. In an alternate embodiment, the system control center may be located at a remote location away from logging tool 1326, such as the surface or in a different borehole, and performs the statistical processing accordingly. These and other variations within the present disclosure will be readily apparent to those ordinarily skilled in the art having the benefit of this disclosure.

FIG. 13B illustrates an alternative embodiment of the present disclosure whereby a wireline acoustic logging tool acquires and generates slowness signals. At various times during the drilling process, drill string 1308 may be removed from the borehole as shown in FIG. 13B. Once drill string 1308 has been removed, logging operations can be conducted using a wireline acoustic logging sonde 1334, i.e., an acoustic probe suspended by a cable 1341 having conductors for transporting power to the sonde and telemetry from the sonde to the surface. A wireline acoustic logging sonde 1334 may have pads and/or centralizing springs to maintain the tool near the axis of the borehole as the tool is pulled uphole. Acoustic logging sonde 1334 can include a variety of transmitters/receivers for measuring acoustic anisotropy. A logging facility 1343 collects measurements from logging sonde 1334, and includes a computer system 1345 for processing and storing the slowness measurements gathered by the sensors, as described herein.

In certain illustrative embodiments, the system control centers utilized by the acoustic logging tools described herein include at least one processor embodied within system control center and a non-transitory and computer-readable storage, all interconnected via a system bus. Software instructions executable by the processor for implementing the illustrative processing methods described herein in may be stored in local storage or some other computer-readable medium. It will also be recognized that the statistical processing software instructions may also be loaded into the storage from a CD-ROM or other appropriate storage media via wired or wireless methods.

Moreover, those ordinarily skilled in the art will appreciate that various aspects of the disclosure may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present disclosure. The disclosure may be practiced in distributed-computing environments where tasks are performed by remote-processing devices that are linked through a communications network. In a distributed-computing environment, program modules may be located in both local and/or remote computer-storage media including memory storage devices. The present disclosure may therefore, be implemented in connection with various hardware, software or a combination thereof in a computer system or other processing system.

Accordingly, the illustrative methods described herein provide new methods of using both amplitude and phase information of receiver array waveforms to constrain the slowness picks. The methods eliminate the need of using time-slowness mask techniques for slowness picking, which can cause the inaccurate picks if it is defined inappropriate. The illustrative methods may be utilized in the extraction of Stoneley slowness, low-frequency flexural slowness, low-frequency screw slowness, and borehole refracted compressional wave slowness. Moreover, prior slowness pick or existing slowness picks from other wave modes may be used to validate the slowness pickings and remove outlier noises for slowness estimations. The methods may be applied in real-time or post processing or planning.

Embodiments and methods of the present disclosure described herein further relate to any one or more of the following paragraphs:

1. A downhole acoustic logging method, comprising acquiring acoustic waveforms of a borehole; applying a first-arrival-picking (“FAP”) technique to derive first slowness picks of the acquired acoustic waveforms, the FAP technique being based on waveform amplitude;

applying a waveform phase coherence technique to derive second slowness picks of the acquired acoustic waveforms; comparing the first and second slowness picks; determining final slowness picks based on the comparison; and performing a borehole operation using the final slowness picks.

2. The method as defined in paragraph 1, wherein the FAP and waveform phase coherence techniques are applied simultaneously.

3. The method as defined in paragraphs 1 or 2, wherein the FAP and waveform phase coherence techniques are applied sequentially.

4. The method as defined in any of paragraphs 1-3, wherein the sequential application comprises applying the FAP technique before the waveform phase coherence technique to thereby select the first slowness picks; determining a slowness search range based upon the first slowness picks; and applying the slowness search range to the waveform phase coherence technique to thereby constrain the second slowness picks.

5. The method as defined in any of paragraphs 1-4, wherein determining the final slowness picks comprises determining a distance of the second slowness picks from the first slowness picks; and selecting a maximum coherence peak of the second slowness picks based upon the distance, wherein the second slowness picks having the maximum coherence peak or most consistent slowness and travel times are the final slowness values.

6. The method as defined in any of paragraphs 1-5, wherein determining the final slowness picks comprises sequentially determining a distance of the second slowness picks from the first slowness picks; and selecting the second slowness picks based upon the distance, wherein the second slowness picks having a minimum distance to the first slowness picks are the final slowness values.

7. The method as defined in any of paragraphs 1-6, wherein the acoustic waveforms are acquired using an acoustic logging tool positioned along a wireline or drilling assembly.

8. The method as defined in any of paragraphs 1-7, wherein the borehole operation comprises well planning or formation evaluation.

9. A downhole acoustic logging method, comprising acquiring acoustic waveforms of a borehole; and utilizing amplitude and phase data of the acquired acoustic waveform to determine slowness picks.

10. The method as defined in paragraph 9, wherein utilizing the amplitude data comprises applying a first-arrival-picking (“FAP”) technique to the acquired acoustic waveforms; and utilizing the phase data comprises applying a waveform phase coherence technique to the acquired acoustic waveforms.

11. The method as defined in paragraphs 9 or 10, wherein the FAP and waveform phase coherence techniques are applied simultaneously.

12. The method as defined in any of paragraphs 9-11, wherein the FAP and waveform phase coherence techniques are applied sequentially.

13. The method as defined in any of paragraphs 9-12, further comprising performing a downhole operation using the slowness picks.

14. A downhole acoustic logging system, comprising a logging tool; and a processor communicably coupled to the logging tool to cause the system to perform any one of the methods of paragraphs 1-13.

Moreover, the foregoing paragraphs and other methods described herein may be embodied within a system comprising processing circuitry to implement any of the methods, or a in a non-transitory computer-readable medium comprising instructions which, when executed by at least one processor, causes the processor to perform any of the methods described herein.

Although various embodiments and methods have been shown and described, the disclosure is not limited to such embodiments and methodologies and will be understood to include all modifications and variations as would be apparent to one skilled in the art. Therefore, it should be understood that the disclosure is not intended to be limited to the particular forms disclosed. Rather, the intention is to cover all modifications, equivalents and alternatives falling within the spirit and scope of the disclosure as defined by the appended claims.

1. A downhole acoustic logging method, comprising:
acquiring acoustic waveforms of a borehole;
applying a first-arrival-picking (“FAP”) technique to derive first slowness picks of the acquired acoustic waveforms, the FAP technique being based on waveform amplitude;
applying a waveform phase coherence technique to derive second slowness picks of the acquired acoustic waveforms;
comparing the first and second slowness picks;
determining final slowness picks based on the comparison; and
performing a borehole operation using the final slowness picks.

2. The method as defined in claim 1, wherein the FAP and waveform phase coherence techniques are applied simultaneously.

3. The method as defined in claim 1, wherein the FAP and waveform phase coherence techniques are applied sequentially.

4. The method as defined in claim 3, wherein the sequential application comprises:
applying the FAP technique before the waveform phase coherence technique to thereby select the first slowness picks;
determining a slowness search range based upon the first slowness picks; and
applying the slowness search range to the waveform phase coherence technique to thereby constrain the second slowness picks.

5. The method as defined in claim 1, wherein determining the final slowness picks comprises:
determining a distance of the second slowness picks from the first slowness picks; and
selecting a maximum coherence peak of the second slowness picks based upon the distance,
wherein the second slowness picks having the maximum coherence peak or most consistent slowness and travel times are the final slowness values.

6. The method as defined in claim 1, wherein determining the final slowness picks comprises:
sequentially determining a distance of the second slowness picks from the first slowness picks; and
selecting the second slowness picks based upon the distance,
wherein the second slowness picks having a minimum distance to the first slowness picks are the final slowness values.

7. The method as defined in claim 1, wherein the acoustic waveforms are acquired using an acoustic logging tool positioned along a wireline or drilling assembly.

8. The method as defined in claim 1, wherein the borehole operation comprises well planning or formation evaluation.

9. A downhole acoustic logging method, comprising:
acquiring acoustic waveforms of a borehole; and
utilizing amplitude and phase data of the acquired acoustic waveform to determine slowness picks.

10. The method as defined in claim 9, wherein:
utilizing the amplitude data comprises applying a first-arrival-picking (“FAP”) technique to the acquired acoustic waveforms; and
utilizing the phase data comprises applying a waveform phase coherence technique to the acquired acoustic waveforms.

11. The method as defined in claim 10, wherein the FAP and waveform phase coherence techniques are applied simultaneously.

12. The method as defined in claim 10, wherein the FAP and waveform phase coherence techniques are applied sequentially.

13. The method as defined in claim 9, further comprising performing a downhole operation using the slowness picks.

14. A downhole acoustic logging system, comprising:
a logging tool; and
a processor communicably coupled to the logging tool to cause the system to perform the method of claim 1.

15. A non-transitory computer-readable medium comprising instructions which, when executed by at least one processor, causes the processor to perform the method of claim 1.
